(19) United States
(12) Patent Application Publication
(10) Pub. No.: US 2010/0223833 A1
(43) Pub. Date: Sep. 9, 2010

(54) Non-Rotational, Self-Correcting, Point-On-Top, Hook

(76) Inventor: Jan Jay Rigney, Owasso, OK (US)

Correspondence Address: Jan Jay Rigney, 11880 E. 86th St N., Owasso, OK, 74055, US

(21) Appl. No.: 12/400,731

(22) Filed: Mar. 9, 2009

(51) Int. Cl. A01K 83/06

(52) U.S. Cl. 43/42.22; 43/44.81; 43/42.39

(57) ABSTRACT

A fishing hook having a shank, bend, eye, and point having a specific gravity greater than that of water is combined with a weight also having a density greater than that of water, and is additionally combined with a buoyant floating body which has a density less than that of water. The combination is arranged so that the hook, weight, and buoyant floating body being co operable together to cause the hook to orient in a more or less horizontal position, with the bend of the hook going “up”, and the point of the hook maintained in a position “on top” of or above the shank, and facing forward, and will not rotate sideways or backwards. This orientation is maintained at all times and is self correcting at all times; whether the lure is fished on the surface of the water, or suspended under the surface of the water, or while sinking and falling toward the bottom, or resting on the bottom, or while being drawn over underwater obstacles. Furthermore, this orientation is not dependent upon the contour of the bottom surface to maintain that position. Additionally, the maintaining of the orientation is not dependent upon the lure being suspended from the string, or dependent upon the lure orienting in the hook up position because it is being retrieved.

### BACKGROUND

Different lures have been made which attempt to control the position of the hook in order to help prevent hanging up with underwater structures, or to aid in the position of the lure to enhance the hooking of the fish. Woolfe describes a method for placing the weight of the hook on the shank such that the lure rests on the bottom with shank up and the point facing forward. However this design is totally dependent upon the bottom contour which the lure rests upon to cause the hook to orient on top. If the bottom contour which the lure rests upon is at a steep side angle, the lure falls over and the hook can turn to it's side rotating in a manner allowing it to hang up. There is no method in his design for the lure to right itself once it falls over. Furthermore if the lure is pulled off the bottom so that the lure “dangles” from the string, such as would happen if the string is thrown over a submerged branch, or if the lure is retrieved over underwater branches; once off the bottom, the lure and hook can then rotate 360 degrees in a circle or partial circle, rotating around the same axis as the string and eye, and shank as the lure “dangles” allowing the hook to then turn or rotate or spin with the point on bottom and point down as it is pulled over underwater structures causing it to hang up.

There are also various floating surface lures that can be fished with the hook position “up”, but the lure must land right side “up” after it is cast, in order for the hook position to be “up”. That is, if the lure lands upside down on the cast, it has no means to re-orient itself or “self correct” properly into the correct hook “up” position, and the fisherman must retrieve the lure and recast hoping the lure doesn't get hung up while reeling it back in, and then, again, “hope” the lure will land right side (hook) “up” on the subsequent cast.

There has also been suspending lures that have been made that do orient with the hook “up” as they are dangled from the string in the water or out of the water, but the moment these lures encounter the bottom, or rest on the bottom, or if they are retrieved over an underwater obstacle, the hook point falls over to the side as the point rotates about the axis of the shank and the hook point is not maintained “up” with the point on top, and there is no means for self-correcting the hook orientation, allowing them to hang up.

Other lures have been made with a flat bottom in order address this problem, but they are dependent on the contour of the bottom (as is Woolfe) to orient the hook. There are also flat bottom lure used to cause the body portion of the lure to “stand-up” off the bottom as it is fished on the bottom. Again, this design is totally dependent upon the bottom contour to cause the hook to orient on top. If the bottom is at a steep side angle the lure falls over and the hook can turn to it's side rotating in a manner allowing it to hang up. Again, if the lure is pulled off the bottom such as would happen if the string is thrown over a submerged branch, once off the bottom the lure “dangles” and hook can then rotate 360 degrees in a circle or partial circle, rotating around the same axis as the string.

There are lures that have the hook point “up” as they are retrieved; but if the retrieve is stopped, or if the lure is dragged over underwater obstacles, or if the lure rests on the bottom, the hook falls over and is not maintained in the “up” position and there is no means for self-correcting unless the retrieve is resumed—and then the hook has turned into a position that would allow it to hang up.

Robertaccio describes a hook pointing forward and with the point above the shank, however as his arrangement is fished, the flotation forces of the floating egg portion will soon orient on the outer portion of the hook, and the gravitational force of the point end causes the hook to rotate about the shank of the hook and point backwards and down, as in FIG. 4 of his patent, allowing it to hang up. That is, the arrangement does not consistently MAINTAIN the hook in the proper position and the arrangement “breaks down” or changes to an unwanted arrangement as it is fished. The buoyant portion soon arranges itself as in FIG. 4 of his patent. This causes the hook to then orient backwards and down allowing it to hang up. There is no self-correcting method for maintaining the hook position. The lure must be retrieved; the arrangement then has to be reconfigured by the fisherman before he recasts the lure. Another problem with Robertaccio's patent is that because the hook does not incorporate a weight, it is limited in its ability to be cast effectively. My hook has an additional advantage over Robertaccio's patent, in that as my hook is fished on top of the surface of the water where there is floating grass, or lillypads, or moss; my non-rotational, self correcting, point on top, hook, has the hook point itself extending out of and above the plane of the water's surface as illustrated in FIGS. 3 and 4 of this patent. Because the hook is not only “up” but also “on top” of the buoyant body, it cannot snag on floating grass, lillypads, or moss—because the hook point and bend is out of and above the plane of the surface of the water. In Robertaccio's design, even IF the hook point happens to orient point up and forward, the balloon portions seek the plane of the surface of the water and the balloon portions are “on top” of the hook and at the plane of the surface of the water, while the bend and point, and especially the shank and eye portions are extending down below the surface—into the water, causing the point itself, and the string, eye, and shank portions to snag or foul up with grass, lillypads, and moss. Yet another undesirable characteristic of Robertaccio's hook patent is that his design causes the hook to “dangle” with the eye of the hook down (whereas most lures have an undesirable “dangle” from the string with the eye up as they are suspended from the string). When his hook “dangles” there is no means to prevent his hook from rotating about the axis of the string as it is pulled over underwater obstacles, or affected by changes in current. The hook can spin or rotate 360 degrees as it “dangles” upward, and if the hook point rotates about the axis of the shank such that the hook point is facing backward, then as the hook is subsequently retrieved and the shank is then pulled upward toward the fisherman, the hook, at that moment, is facing down and forward in an undesirable position that would allow it to easily snag on underwater obstacles.

Rigney (that is, I) in a previous patent, described an arrangement whereby the hook is maintained vertically. However, while the hook is maintained up with respect to the eye, the point could rotate about the axis of the shank of the hook and face sideways or backwards as illustrated in FIG. 6, where the lure is shown both with the hook facing forward and backwards. When the hook point is facing backwards, then as the hook is subsequently retrieved and the shank is then pulled upward toward the fisherman, the hook, at that moment, is facing down and forward in an undesirable position that would allow it to easily snag on underwater obstacles. The “Non-Rotational, Self-Correcting, Point-On-Top, Hook” is a new and improved application, the hook position is more or less horizontal, with the point “up” or “on top” and the hook position is always facing forward and will NOT rotate about the axis of the string or shank of the hook allowing it to face sideways or backwards, and acts further to prevent the hook from getting snagged on underwater structures.

### SUMMARY OF THE INVENTION

There are two separate combination of forces at work to maintain the hook in the proper position; the hook point oriented facing forward, with the shank in a more or less horizontal position, and the hook point on top and above the shank.

The first is a combination of three forces acting together simultaneously to control the orientation of the hook and therefore the lure itself into a more or less horizontal position with the hook facing forward and the hook point “up” or “on top” of or above the shank. The floating force of the buoyant body; and the sinking force of the weight on one end of the lure, plus the sinking force of the bend and point portions on the other end of the hook are specifically arranged and co operable to create a balance much like that of common table scales, orienting the shank in a more or less horizontal position.

The second is a combination of two forces acting together simultaneously, to prevent the hook point from rotating around the axis of the string, eye, or shank in order to maintain the hook point “up” or “on top”. The weight is placed on the hook with the center of gravity below the shank of the hook. At the same time the buoyant body is placed on the hook with the center of gravity above the shank of the hook. These two forces keep the point “up” or “on top” much like a scorpion tail, and PREVENTS the hook from rotating about the axis of the shank of the hook. Furthermore, it also keeps the lure from spinning around in circles as it dangles from the string underwater, it also prevents the hook from rotating to the side as the lure is retrieved over underwater obstacles such as branches, rocks, and cables, keeping the point of the hook “up” or “on top” above the shank of the hook away from the obstacles.

In FIGS. 1, 2, and 5 the bend and point portion of the hook BP, are denser than water and cause the bend and point portion BP to rotate clockwise, while at the same time the Weight portion of the lure W is also denser than water and causes the Weight portion W to rotate counterclockwise. The buoyant Floating Body exerts an upward force FB in between the 2 equal and opposing downward forces, BP and W. The ratios and placement of the center of the upward buoyant floating force FB, the weight W, and Bend and Point BP can be adjusted such that the shank is maintained in a balanced horizontal position—much like that of a weighing scale with 2 tables and a center fulcrum. The floating body FB acting like the fulcrum and the weight W, and bend and point BP act as the tables of the scales.

In FIGS. 3, 4, and 10 the hook H has a center of gravity C1. The weight W has a center of gravity C2 below the center of gravity C1 of the hook. The buoyant floating body is not centered on the shank of the hook. The buoyant floating body is placed on the shank of the hook with its' center of gravity C3 above the eye, shank, and hook. This arrangement and combination is co operable such that if the lure lands in the water upside down the weight causes the lure to rotate about the axis of the hook causing the point to orient “up” or “on top”, above the eye, and shank of the hook. Likewise, and at the same time, the floating buoyant body, also causes the hook point to orient “up” or “on top”. That is, if the lure lands upside-down the buoyancy of the floating body having more floatation on the top portion causes the lure to rotate about the eye and shank of the hook, rolling the lure over, returning the hook point “up” or “on top” of the shank. Additionally, if the lure is simply caused to turn or rotate slightly sideways, there is then more weight above the axis of the eye and shank of the hook and (at the same time) there is then more floatation below the axis of the eye, and shank of the hook, and as a result, these two forces, the sinking of the weight and the floating of the body cause the lure to immediately return to the point “up” or “on top” position.

### BRIEF DESCRIPTION OF THE DRAWINGS

FIG. 1 is a cross sectional side view of the lure as it suspends in the water below the surface. In this embodiment the buoyancy of the floating body is less than the weight and hook so that the lure sinks.

FIG. 2 is a cross sectional side view of the lure as it rests on the surface. In this embodiment the buoyancy of the floating body is greater than the weight and hook so that the lure floats.

FIG. 3 is a front plane view of the lure as it suspends in the water below the surface. In this embodiment the buoyancy of the floating body is less than the weight and hook so that the lure sinks.

FIG. 4 is a front plane view of the lure as it floats on the surface. In this embodiment the buoyancy of the floating body is greater than the weight and hook so that the lure floats.

FIG. 5 is the same view as FIG. 1 and FIG. 2, but with vector force lines added to illustrate orienting and maintaining the hook in the more or less horizontal position.

FIG. 6 is the same view as FIG. 5 but with the balance of the weight shifting down due to a heavier weight being used, causing the lure to orient in a more or less than horizontal position.

FIG. 7 is the same view as FIG. 5 but with the balance of the weight shifting up due to a lighter weight being used, causing the lure to orient in a more or less than horizontal position.

FIG. 8 is the same view as FIG. 5 but with the balance of the buoyancy shifting the bend and point section up due to using a longer and larger buoyant body causing the lure to orient in a more or less horizontal position.

FIG. 9 is the same view as FIG. 5 but with the balance of the buoyancy shifting the bend and point section down due to using a shorter smaller buoyant body causing the lure to orient in a more or less horizontal position.

FIG. 10 is a front plane view showing the rotational forces at work in orienting and maintaining the hook position point “up” or “on top” and facing forward. The weight W has its' center of gravity below the eye E and shank S (that is, there is more sinking material on bottom) but centered equally on the left and right halves of the lure, and at the same time the buoyant floating body FB has it center of gravity above the eye E and shank S (that is, there is more floatational material on top) but centered equally on the left and right halves. These forces cause the hook point P to be maintained “up” or “on top” of the lure.

FIG. 11 is a front plane view showing how the rotational force of the weight keeps the point “up” or “on top”. If the lure is tilted counterclockwise, there becomes more weight on the right side of the lure (see that the amount of weight in the shaded area off-center is much greater on the right side as compared to the amount of weight in the non-shaded area off-center on the left side) as a result, gravity pulls the right side back down until the lure sits centered with equal amount of weight on the left and right sides as in FIGS. 3 and 4 and 10.

FIG. 12 is a front plane view showing that at the same time that the weight is acting to orient the hook in the on top, point up position the rotational force of the buoyancy is also acting to keep the point on top. If the lure is tilted counterclockwise, There becomes more buoyant body on the left side of the lure (see that the amount of buoyant body in the shaded area off-center is much greater on the left side as compared to the amount of buoyant body in the non-shaded area off-center on the right side) as a result, the floatational force pulls the left side back up until the lure sits centered with equal amount of buoyant body on the left and right sides as in FIGS. 3 and 4 and 10.

FIG. 13 is an elevation view illustrating a typical retrieval path pattern and the resultant orientation of the hook position: more or less horizontal and with the point facing forward at all times, and the point of the hook maintained “up” or “on top” so that it resists hanging up.

### DETAILED DESCRIPTION OF THE INVENTION

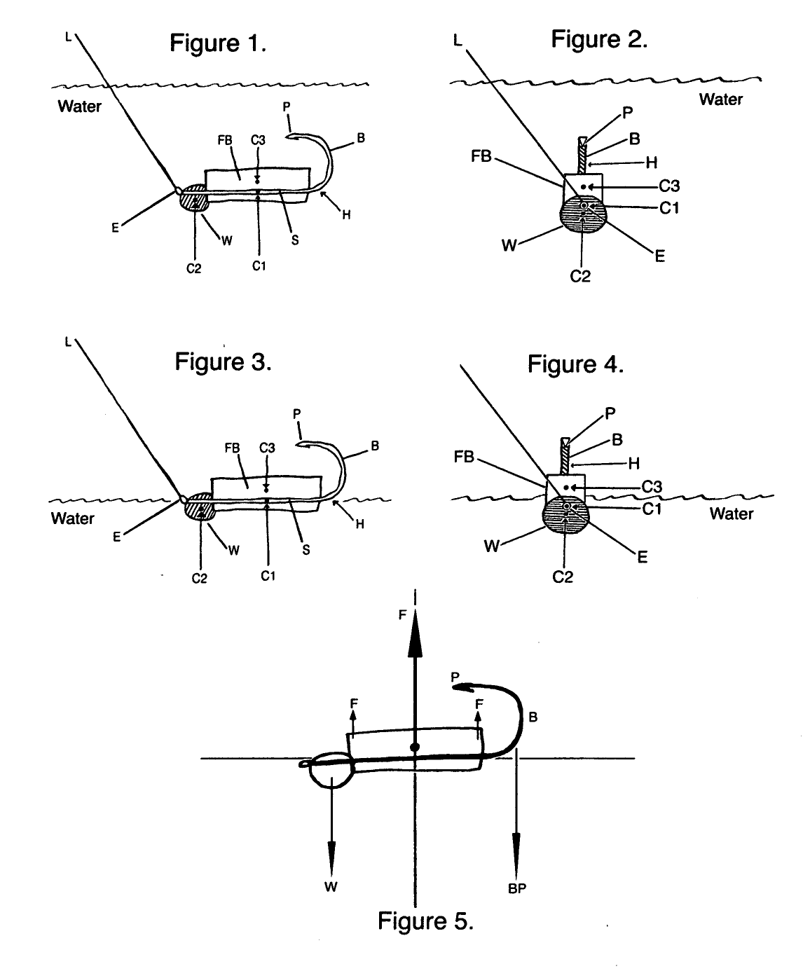

FIG. 1. A fish hook H having a shank S with an eye E, bend B, and point P, having a center of gravity C1. The Hook H has a density or specific gravity greater than that of water and will sink in the water unless a counterbalancing or retrieval force is applied to hook H through the fishing line L, which is connected to the eye E. A weight W is connected at or near the eye E of the hook H. The weight W has a density or specific gravity grater than that of water and will sink. The weight W has its' center of gravity C2 located below the shank S and eye E of the hook H such that there is more sinking force located below the shank S and eye E of the hook H. A floating body FB is placed on the hook H off center with its' center of gravity C3 above the shank S and eye E of the hook H such that there is more floatational force located above the shank S and eye E of the hook H.

FIG. 2. A front view of hook H, weight W, eye E, bend of hook B and point P of hook H. A floating body FB is placed on the hook H with its' center of gravity C3 above the shank S and eye E of the hook H. The weight W has its' center of gravity C2 below the shank S and eye E of the hook H. The hook H center of gravity is along the shank S which cannot be seen on this view but is labeled as C1.

FIG. 5. A side view showing the forces at work in orienting the hook in a more or less horizontal position. The weight W exerts a downward force W on the left hand side of the Y axis, which causes the body of the lure to rotate counterclockwise. The weight of the bend and point BP, exerts a downward force BP on the right half of the Y axis, which causes the body of the lure to rotate clockwise. At the same time, the floating body exerts an upward force F in the center of the Y axis. When the weights of W=BP and F is in the center, the lure will sit perfectly horizontal. If F upward floating force is greater than W+BP combined downward force, then the lure will float. If F upward force is less than W+BP combined downward force, then the lure will sink. In either case if W=BP and F is in the center, the lure orients perfectly horizontal.

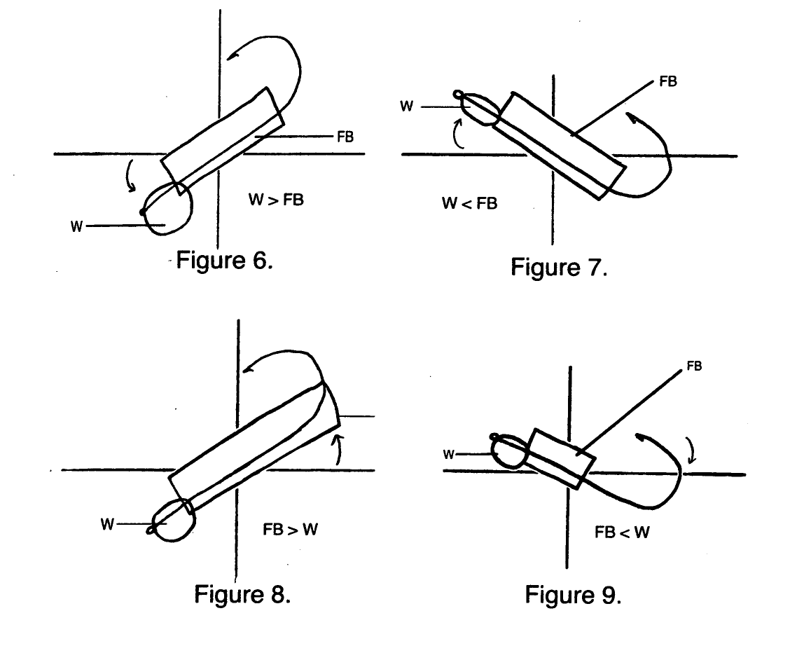

FIG. 6. A side view showing the forces at work in orienting the hook in a more or less horizontal position when the weight W is greater than BP. The weight W exerts a downward force W on the left hand side of the Y axis, which causes the body of the lure to rotate counterclockwise. The weight of the bend of the hook B and point of the hook P, exerts a downward force BP on the right half of the Y axis, which causes the body of the lure to rotate clockwise. At the same time, the floating body exerts an upward force F in the center of the Y axis. When W is greater than BP the lure will sit rotated counterclockwise. If F upward floating force is greater than W+BP combined downward force then the lure will float. If F upward force is less than W+BP combined downward force then the lure will sink. In either case if W is greater than BP the lure orients rotated counterclockwise.

FIG. 7. A side view showing the forces at work in orienting the hook in a more or less horizontal position when the weight W is less than BP. The weight W exerts a downward force W on the left hand side of the Y axis, which causes the body of the lure to rotate counterclockwise. The weight of the bend of the hook B and the point of the hook P, exerts a downward force BP on the right half of the Y axis, which causes the body of the lure to rotate clockwise. At the same time, the floating body exerts an upward force F in the center of the Y axis. When W is less than BP the lure will sit rotated clockwise. If F upward floating force is greater than W+BP combined downward force then the lure will float. If F upward force is less than W+BP combined downward force then the lure will sink. In either case if W is less than BP the lure orients rotated clockwise.

FIG. 8. A side view showing the forces at work in orienting the hook in a more or less horizontal position when the buoyant floating body is larger. If the floatational upward force F of the floating body is greater on the right side of the Y axis, this floatational upward force F counteracts the downward sinking force of BP and lessens or counteracts the net weight such that the weight W is greater than BP down+F up. And causes the lure to rotate counterclockwise. If F upward floating force is greater than W+BP combined downward force then the lure will float. If F upward force is less than W+BP combined downward force then the lure will sink. In either case if W is greater than BP down+F up, the lure orients rotated counterclockwise.

FIG. 9. A side view showing the forces at work in orienting the hook in a more or less horizontal position when the buoyant floating body is smaller. If the buoyancy of the floating body is less on the right side of the Y axis and greater on the left side of the Y axis, there is less upward floating upward force F to counteract the downward sinking force of BP and the weight of BP has less opposing upward force such that the weight BP is greater than force of W down+F up, and causes the lure to rotate clockwise. If F upward floating force is greater than W+BP combined downward force then the lure will float. If F upward force is less than W+BP combined downward force then the lure will sink. In either case if W+F is greater than BP down, the lure orients rotated clockwise.

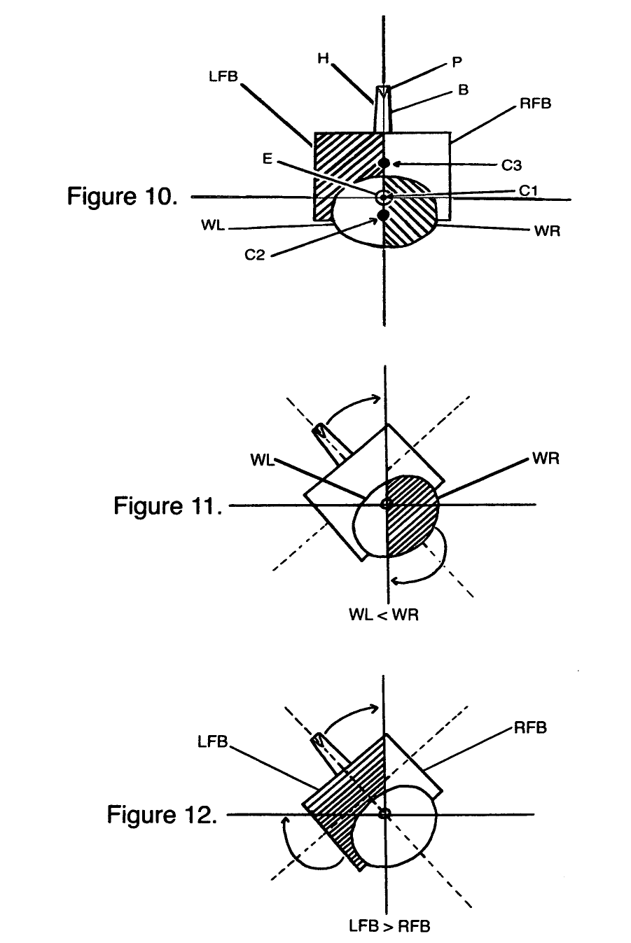

FIG. 10. A front plane view showing how all the rotational forces of the weight and buoyant body are equal as there is a balance of forces on the right side and left side. The Weight WR on the right half of the Weight W is equal to the Weight WL on the left half of the Weight W There is equal amount of weight on the right half as the left so WL=WR. At the same time, the right half of the buoyant floating body RFB is equal to the floatation on the left half of the buoyant floating body LFB. There is equal amount of floatation on the right half as the left so LFB=RFB. As a result, all these forces acting together, cause the lure to orient with the hook point “up”, and the hook point is maintained “on top”.

FIG. 11. A front view of the self-correcting or balancing rotational forces exerted along the (Z) axis of the shank S or eye E by the sinking gravitational force of the weight W. If the lure encounters an obstacle which causes the lure to spin or rotate or flip over toward its' side, the majority of the weight W is then greater toward, or ultimately on, the top. The heavier portion is then pulled by gravity and it immediately causes the lure to rotate about the axis of the shank S, or eye E, causing the point P of the hook to return immediately or “self-correct” to a position with the hook point P “up” or “on top” of the lure.

FIG. 12. A front view of the self-correcting or balancing rotational forces exerted along the (Z) axis of the shank S or eye E by the buoyant floating force of the floating body FB. If the lure encounters an obstacle which causes the lure to spin or rotate or flip over, the majority of the floating body FB is then greater toward, or ultimately on, the bottom. The more floatation portion is then pulled by the floating buoyancy and immediately causes the lure to rotate about the axis of the shank S, or eye E, causing the point P of the hook to return immediately or “self-correct” to a position with the point P “up” or “on top” of the lure.

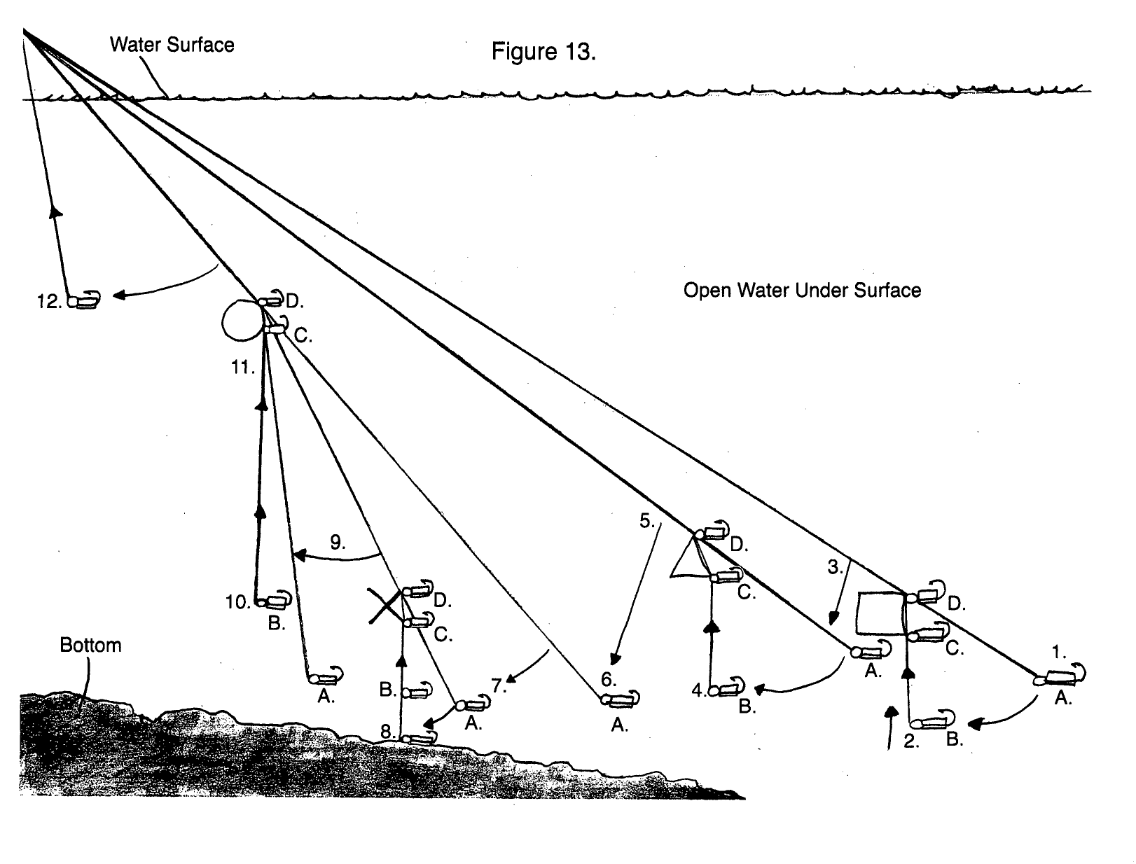

FIG. 13. The operation of the “non-rotational, self-correcting, point on top, hook” in the water is illustrated. A single cast into the open water past submerged structures a square, triangle, the bottom, X, and O. The lure free falls (A) from position 1. and then “dangles” (B) over the underwater object a square. The lure maintains the hook on top position as it “dangles” and is pulled up to encounter the bottom edge and is dragged along (C) the structure. The hook maintains the horizontal point up position as it is dragged along the structure, it does not roll over or rotate to the left or right, it then is pulled over the top edge (D) of the square structure. The hook stays “up” and “on top” at (D) and does not roll over to hang up on the structure. As the lure is continued to be retrieved it again falls at 3. and remains in the hook “up” position as it free falls (A) to rest at 4. again dangling (B) over the underwater structure a triangle. The lure maintains the hook on top position as it “dangles” and is pulled up to encounter the bottom edge and is dragged along (C) the structure a triangle. The hook maintains the horizontal point up position as it is dragged along the structure, it does not roll over or rotate to the left or right, it then is pulled over the top edge (D) of the triangle structure. The hook stays “up” and “on top” at (D) and does not roll over to hang up on the structure. As the lure is continued to be retrieved it again free falls (A) at 5. and remains in the hook “up” position as it free falls (A) to rest ultimately on the bottom at 8. Then again dangling (B) over the underwater structure X. As the lure is continued to be retrieved it again the lure maintains the hook on top position as it “dangles” and is pulled up to encounter the bottom edge and is dragged along (C) the structure X. The hook maintains the horizontal point up position as it is dragged along the structure, it does not roll over or rotate to the left or right, it then is pulled over the top edge (D) of the X structure. The hook stays “up” and “on top” at (D) and does not roll over to hang up on the structure. As the lure is continued to be retrieved it again free falls (A) at 9. and remains in the hook “up” position as it free falls (A) to again “dangle at 10. Then again dangling (B) over the underwater structure O. The hook always stays in the “up’ or “on top” position whether it is free falling (A), dangling (B), encounters the bottom edge of a structure and is dragged along (C), or pulled over the top edge (D). As it is continued to be retrieved over O it free falls to 12. and ultimately retrieved out of the water.

Whether on the bottom; over branches; on irregular uneven surfaces; over submerged cables; in the open water; on the open surface; or on grass, the hook does not rotate or spin about the axis of the line, shank, or eye. The lure maintains the more or less horizontal position and does not “dangle” or “spin” on the string. Additionally, the hook point is maintained on the top at all times like a scorpion tail. If it encounters an underwater structure that causes it to rotate to the left or right, it immediately “self-corrects” the position to the hook “up” or “on-top” position.

Thus it is apparent that there has been provided, in accordance with the invention, a “non-rotational, self-correcting, point-on-top, hook”. The maintained hook position is such that the hook point is always on top preventing it from rotating to the left or right or backwards which may allow it to hang up. While the invention has been described with specific embodiments thereof, it is evident that many alternatives, modifications, and variations will be apparent to those skilled in the art and in light of the foregoing descriptions. Accordingly it is intended to embrace all such alternatives, modifications, and variations as fall within the spirit of the appended claims.

What is claimed is:

1. A combination comprising a fishing hook having an eye at one end, a shank, and a bend and a point at the other end, having a density or specific gravity greater than that of water; and a weight having a density greater than that of water, placed near the eye end of the hook, that weight is placed on the hook with its' center of gravity below that of the hook; and a buoyant body having a density or specific gravity less than that of water, that buoyant body is placed on the hook in between the bend and point end of the hook and the eye and weight end, with its' center of gravity above that of the hook; said hook, weight, and buoyant body being co operable together to cause the hook to orient with the shank in a more or less horizontal position, with the bend of the hook going up, and the point of the hook maintained in a position on top.

2. A combination comprising a fishing hook having an eye at one end, a shank, and a bend and a point at the other end, having a density or specific gravity greater than that of water; and a weight having a density greater than that of water, placed near the eye end of the hook, that weight is placed on the hook with its' center of gravity below that of the hook; and a buoyant body having a density or specific gravity less than that of water, that buoyant body is placed on the hook in between the bend and point end of the hook and the eye and weight end, with its' center of gravity above that of the hook; said hook, weight, and buoyant body being co operable together to cause the hook to orient with the shank in a more or less horizontal position, with the bend of the hook going up, and the point of the hook maintained in a position on top, and that position is maintained without the aid of the lure resting on the bottom.

3. A combination comprising a fishing hook having an eye at one end, a shank, and a bend and a point at the other end, having a density or specific gravity greater than that of water; and a weight having a density greater than that of water, placed near the eye end of the hook, that weight is placed on the hook with its' center of gravity below that of the hook; and a buoyant body having a density or specific gravity less than that of water, that buoyant body is placed on the hook in between the bend and point end of the hook and the eye and weight end, with its' center of gravity above that of the hook; said hook, weight, and buoyant body being co operable together to cause the hook to orient with the shank in a more or less horizontal position, with the bend of the hook going up, and the point of the hook maintained in a position on top, and that position is maintained even when the hook is dangled from the string as it is submerged or suspended in the water or under the surface of the water.

4. A combination comprising a fishing hook having an eye at one end, a shank, and a bend and a point at the other end, having a density or specific gravity greater than that of water; and a weight having a density greater than that of water, placed near the eye end of the hook, that weight is placed on the hook with its' center of gravity below that of the hook; and a buoyant body having a density or specific gravity less than that of water, that buoyant body is placed on the hook in between the bend and point end of the hook and the eye and weight end, with its' center of gravity above that of the hook; said hook, weight, and buoyant body being co operable together to cause the hook to orient with the shank in a more or less horizontal position, with the bend of the hook going up, and the point of the hook maintained in a position on top, and that position is maintained even when the hook is retrieved or drawn or pulled over underwater obstacles, such as, but not limited to, sticks, or rocks, or underwater cables.

5. A combination comprising a fishing hook having an eye at one end, a shank, and a bend and a point at the other end, having a density or specific gravity greater than that of water; and a weight having a density greater than that of water, placed near the eye end of the hook, that weight is placed on the hook with its' center of gravity below that of the hook; and a buoyant body having a density or specific gravity less than that of water, that buoyant body is placed on the hook in between the bend and point end of the hook and the eye and weight end, with its' center of gravity above that of the hook; said hook, weight, and buoyant body being co operable together to cause the hook to orient with the shank in a more or less horizontal position, with the bend of the hook going up, and the point of the hook maintained in a position on top extending out of and above the plane of the surface of the water, and that position is maintained as the lure is fished on the surface.

6. A combination comprising a fishing hook having an eye at one end, a shank, and a bend and a point at the other end, having a density or specific gravity greater than that of water; and a weight having a density greater than that of water, placed near the eye end of the hook, that weight is placed on the hook with its' center of gravity below that of the hook; and a buoyant body having a density or specific gravity less than that of water, that buoyant body is placed on the hook in between the bend and point end of the hook and the eye and weight end, with its' center of gravity above that of the hook; said hook, weight, and buoyant body being co operable together to cause the hook to orient with the shank in a more or less horizontal position, with the bend of the hook going up, and the point of the hook maintained in a position on top preventing the hook point form rotating or turning about the axis of the eye and shank of the hook.

7. A combination comprising a fishing hook having an eye at one end, a shank, and a bend and a point at the other end, having a density or specific gravity greater than that of water; and a weight having a density greater than that of water, placed near the eye end of the hook, that weight is placed on the hook with its' center of gravity below that of the hook; and a buoyant body having a density or specific gravity less than that of water, that buoyant body is placed on the hook in between the bend and point end of the hook and the eye and weight end, with its' center of gravity above that of the hook; said hook, weight, and buoyant body being co operable together to cause the hook to orient with the shank in a more or less horizontal position, with the bend of the hook going up, and the point of the hook maintained in a position on top and self-correcting the hook orientation in order to maintain it in the more or less horizontal position, with the bend of the hook going up, and the point of the hook maintained in a position on top, preventing the hook point form rotating or turning about the axis of the eye and shank of the hook.
